(19) United States
(12) Patent Application Publication
(10) Pub. No.: US 2018/0216202 A1
(43) Pub. Date: Aug. 2, 2018

(54) MULTI-PURPOSE BARREL EVAPORATOR AND METHODS OF MAKING THE SAME

(71) Applicant: Vermont Evaporator Company, LLC, Montpelier, VT (US)

(72) Inventor: Justin William McCabe, Montpelier, VT (US)

(21) Appl. No.: 15/883,186

(22) Filed: Jan. 30, 2018

Related U.S. Application Data
(60) Provisional application No. 62/452,278, filed on Jan. 30, 2017.

(51) Int. Cl. C13B 25/02

(52) U.S. Cl. CPC C13B 25/02

(57) ABSTRACT

A cylindrical frame is fabricated to provide for a tray and heating system that facilitates the condensing of liquid through the process of evaporation. In exemplary embodiments, the barrel evaporator provides a suitable heating system to allow for evaporation at a rate at or above 4 gallons per hour on a tray that has approximately 600 square inches of surface area. In exemplary embodiments, the barrel evaporator has a removable tray that can be replaced by grill grates to allow for uses other than evaporating liquids.

### RELATED APPLICATIONS

This application claims priority to U.S. Provisional Application No. 62/452,278, filed Jan. 30, 2017 and titled “Multi-Purpose Barrel Evaporator”, which is incorporated herein in its entirety.

### FIELD OF THE INVENTION

The present invention generally relates to evaporation devices. In particular, the present invention is directed to a multi-purpose barrel evaporator and methods of making the same.

### BACKGROUND

Syrups, such as maple syrup, birch syrup, and apple cider syrup are traditionally made by concentrating a sugar laden liquid, such as, respectively, maple sap, birch sap, and apple cider to a point where the sugar concentration/viscosity of the sugar laden liquid is appropriate for use as a syrup. Many methodologies have been devised to accomplish syrup making—from simple pots over wood fires to elaborate systems that can include reverse osmosis systems and very large oil fired evaporators (a maple syrup evaporator generally referred to as an “arch”). However, what remains lacking is a highly portable, efficient, and economical evaporator for making all types of syrups.

Additionally, traditional evaporators are single purpose—used a few weeks a year to evaporate sugar laden liquids. This is inconvenient for many homeowners who would rather not invest in, store, and/or build around an arch that is really only used for a few weeks a year. Thus, there is a need for a piece of equipment that can perform different tasks with little to no modification.

### SUMMARY OF THE INVENTION

In a first aspect, a method of constructing an evaporator is disclosed, the method comprising: providing a cylindrical frame; determining a first chord on an end of the cylindrical frame, the first chord having a first and a second end; transferring the first and second ends of the first chord to the opposite end of the cylindrical frame so as to form two parallel longitudinal cut lines; cutting along the two parallel longitudinal cut lines; and bending portions of the cylindrical frame to form a shelf

In another aspect, a barrel evaporator is disclosed, the barrel evaporator comprising: a baffled tray; and a cylindrical frame including a shelf and an opening, the shelf being disposed on two parallel sides of the cylindrical frame, wherein the shelf is designed and configured to support the baffled tray and the opening is sized to allow the baffled tray to rest partially within the cylindrical frame.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a perspective view of a barrel evaporator according to an embodiment of the present invention;

FIG. 2 is a perspective view of a portion of a barrel evaporator according to an embodiment of the present invention;

FIG. 3 is a block diagram of a process of making a barrel evaporator according to an embodiment of the present invention;

FIG. 4 is a cutaway view of a barrel evaporator according to an embodiment of the present invention;

FIG. 5 is a front plan view of a barrel evaporator according to an embodiment of the present invention; and

FIG. 6 is a perspective view of a baffle according to an embodiment of the present invention.

### DETAILED DESCRIPTION

A barrel evaporator according to the present disclosure facilitates the condensing of liquid through the process of evaporation. In exemplary embodiments, the barrel evaporator provides a suitable heating system to allow for evaporation at a rate at or above 4 gallons per hour on a tray that has approximately 600 square inches of surface area. In exemplary embodiments, the barrel evaporator has a removable tray that can be replaced by grill grates to allow for uses other than evaporating liquids.

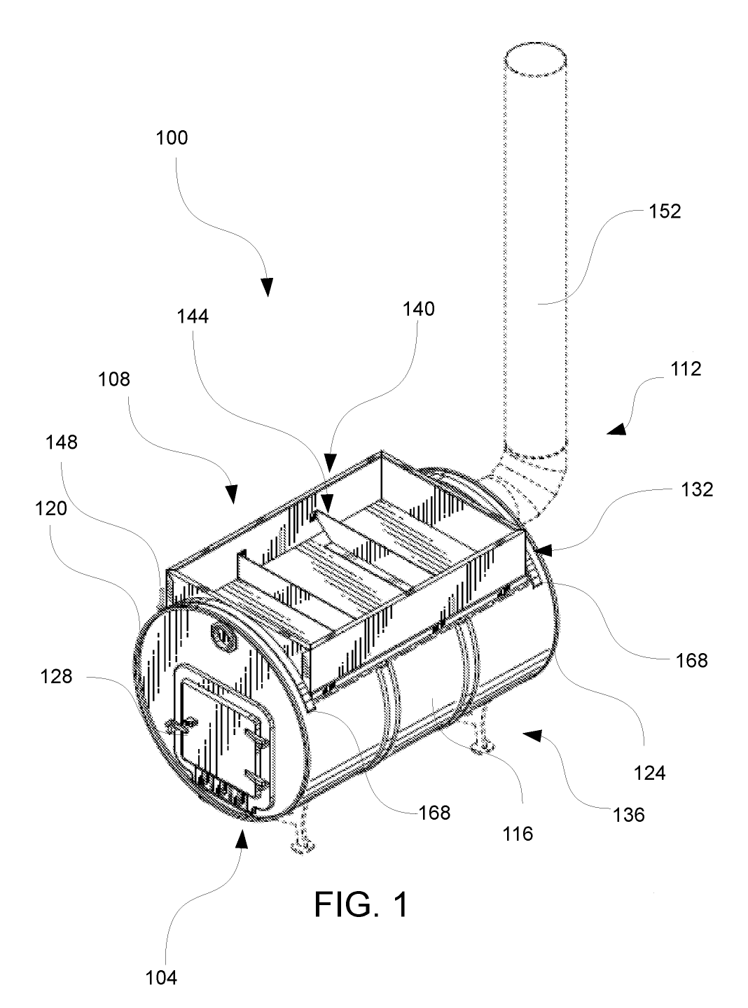

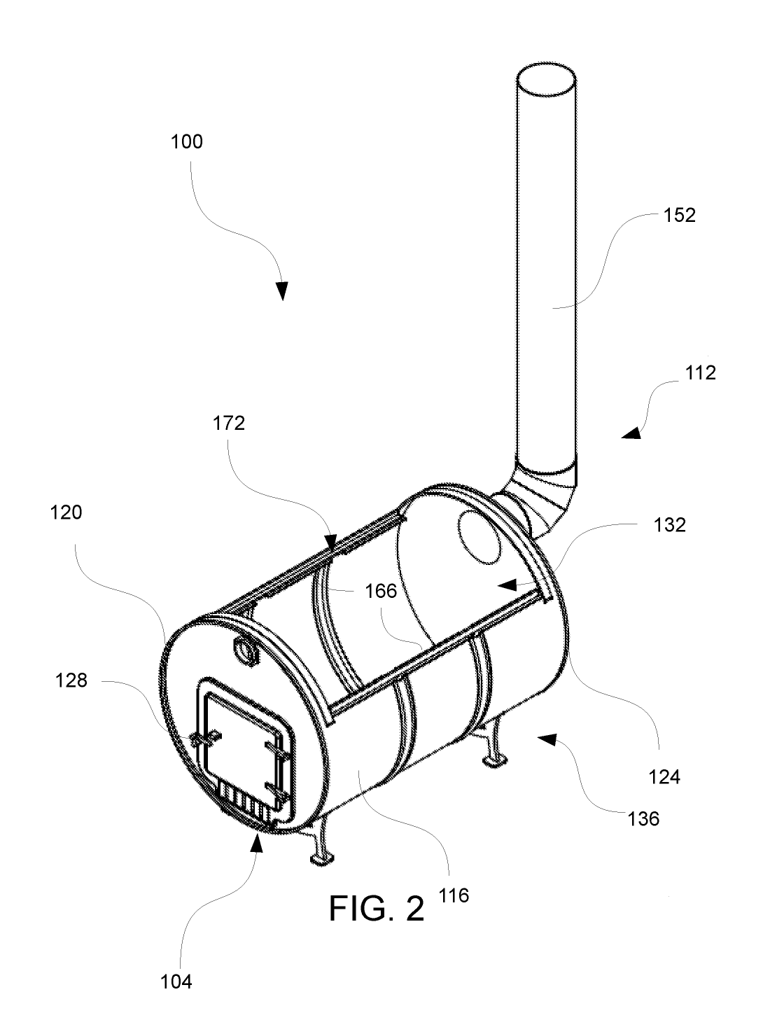

Turning now to the figures, FIGS. 1 and 2 show a barrel evaporator 100 according to an embodiment of the present invention. At a high level, barrel evaporator 100 includes a frame 104, a baffled tray 108, and an exhaust system 112.

Frame 104 is designed and configured to provide an area or enclosure for a heat source to reside. Examples of heat sources within the enclosure include, but are not limited to, a fire box, a propane burner system, and a pellet burner system. The frame 104 is also configured to support baffled tray 108, as discussed in more detail below. In an exemplary embodiment, frame 104 has a body 116 that includes a proximate end 120 and a distal end 124. Proximate end 120 can, in certain embodiments, include a door 128 that facilitates the access to the heat source, when, for example, the heat source is a fire box and wood is used as a fuel. The distal end 124 of frame 104 couples to exhaust system 112.

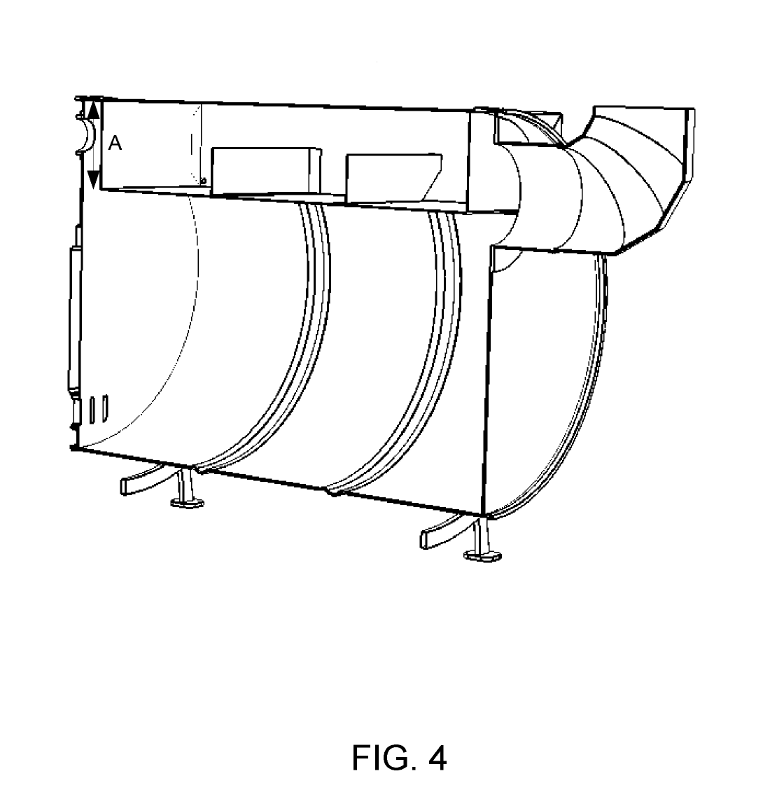

Frame 104 also includes a cutout portion 132 (best seen in FIG. 2) for baffled tray 108. The size and configuration of cutout portion 132 is generally proportional to the shape of baffled tray 108 and sufficient to allow for repeatable insertion and removal of the baffled tray from frame 104. In an exemplary embodiment, cutout portion 132 has a length that is slightly longer than the baffled tray and has a width slightly less than the width of the baffled tray and a depth (into the frame, labeled “A” on FIG. 4) of slightly less than or about the height of the tray. Take, for example, a frame 104 the shape and size of a standard 55-gallon steel drum (e.g., dimensions of approximately 23″ in diameter and 34″ long) and baffled tray 108 has dimensions of approximately 20″ by 30″ long by 6″ high, cutout portion 132 can have a length that is slightly longer than the baffled tray, e.g., 31″ and has a width slightly less than the width of the baffled tray, e.g., 19″, and a depth (into the barrel) of slightly less than or about the height of the tray, e.g., 5.5″. One of the advantages of this baffled tray dimension is that the firebox is sufficiently large that enough fuel can be inserted so as to keep the temperature of the barrel evaporator adequate to promote evaporation of water from a water and sugar solution. This temperature, as measured at exhaust system, can be, for example, 350 degrees Fahrenheit or more. Preferably, the temperature is between 500 and 600 degrees Fahrenheit. Baffled tray 108 has a large surface area so as to improve evaporation. Support of baffled tray 108 by frame 104 is discussed in more detail below with respect to process 200.

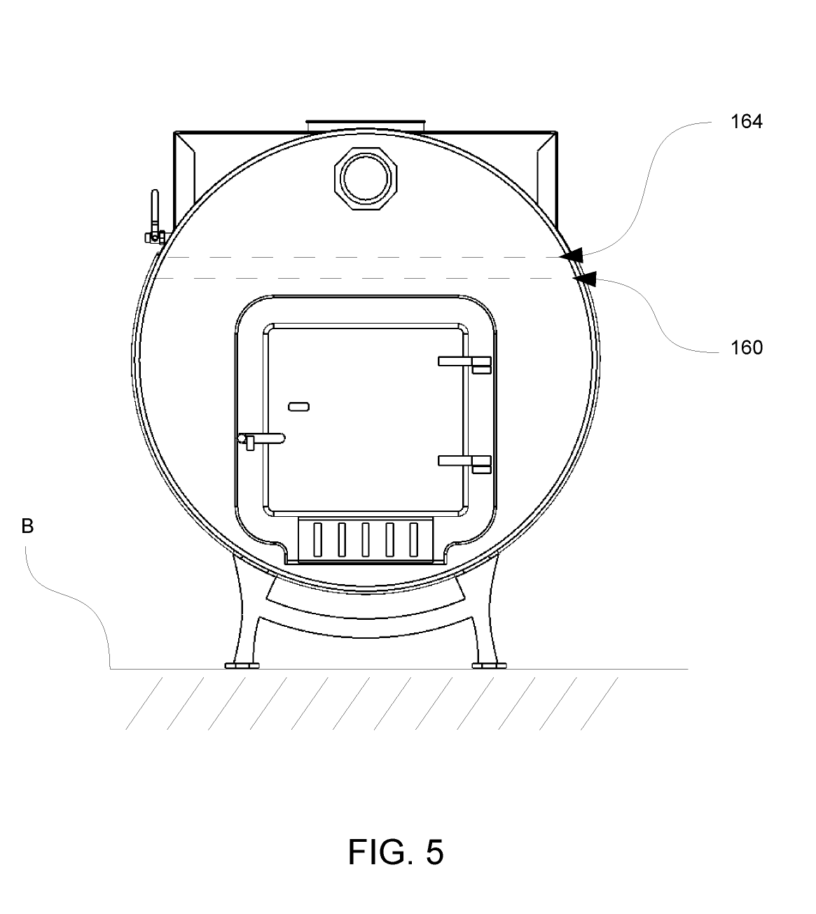

Frame 104 can also be outfitted on a stand or feet 136 to support the frame and keep the frame off a supporting surface (shown in FIG. 5 as “B”), such as the ground.

Baffled tray 108 is designed and configured to facilitate the creation of condensed liquids, e.g., syrup. In an exemplary embodiment, baffled tray 108 is generally rectangular with sides 140 of a sufficient height to contain the liquid contents that are to be evaporated. Baffled tray 108 can include a number of baffles 144 that allow for the concentration of syrup at one end of the baffled tray while sap is added to the opposite corner of the tray thereby sheparding the concentrating sap through apertures 146 in each of the baffles. In an exemplary embodiment, baffled tray 108 includes a valve 148 that is used for removing liquid from the baffled tray that is finished or almost finished syrup. In operation, sap is input at one corner of baffled tray 108, which, as it concentrates, will travel through the apertures as new sap is added. Eventually, the sap will be concentrated enough to remove from the baffled tray 108 using valve 148.

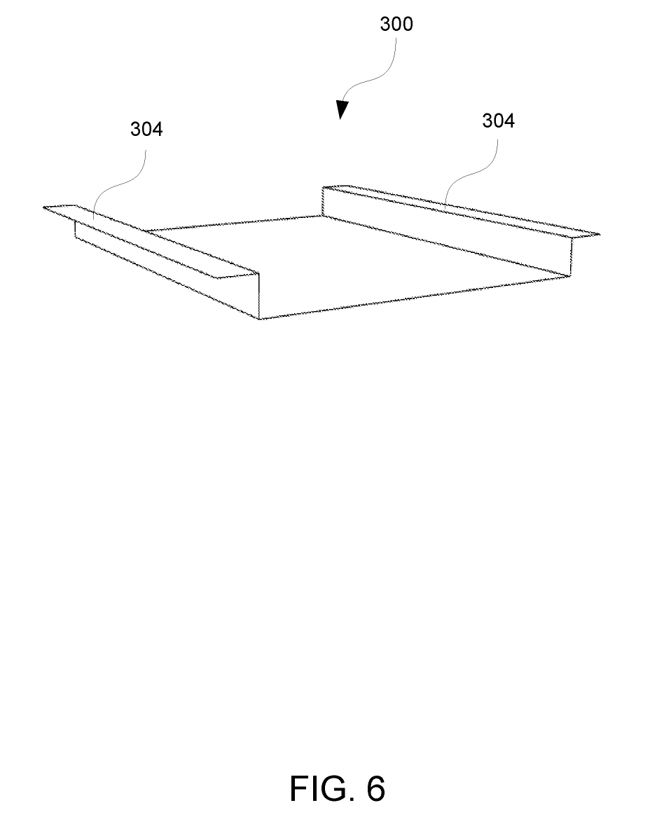

Exhaust system 112, when employed, is designed and configured to remove fuel exhaust generated by during the syrup making process. In an embodiment, exhaust system 112 is coupled to the distal end of frame 104 and includes one or more exhaust pipes 152 that allow for the removal of exhaust from proximate the baffled tray (to avoid ash in the sap). In another embodiment, exhaust system 112 includes a baffle 300 (FIG. 6) that rests on shelf 166 underneath baffled tray 108 that allows the heat source to direct heat to the bottom of baffled tray 108 thereby facilitating the concentration of sap in the baffled tray (via the increased transfer of heat from the heat source to the sap). Baffle 300 has a length that is less than the length of baffled tray 108. In an embodiment, baffle 300 has a U shape with two ledges 304 that run along the longitudinal edges of the baffle. Baffle 300 can have a length of about 24 inches, a width of about 20 inches, and rests under baffled tray 108 by about 2 inches.

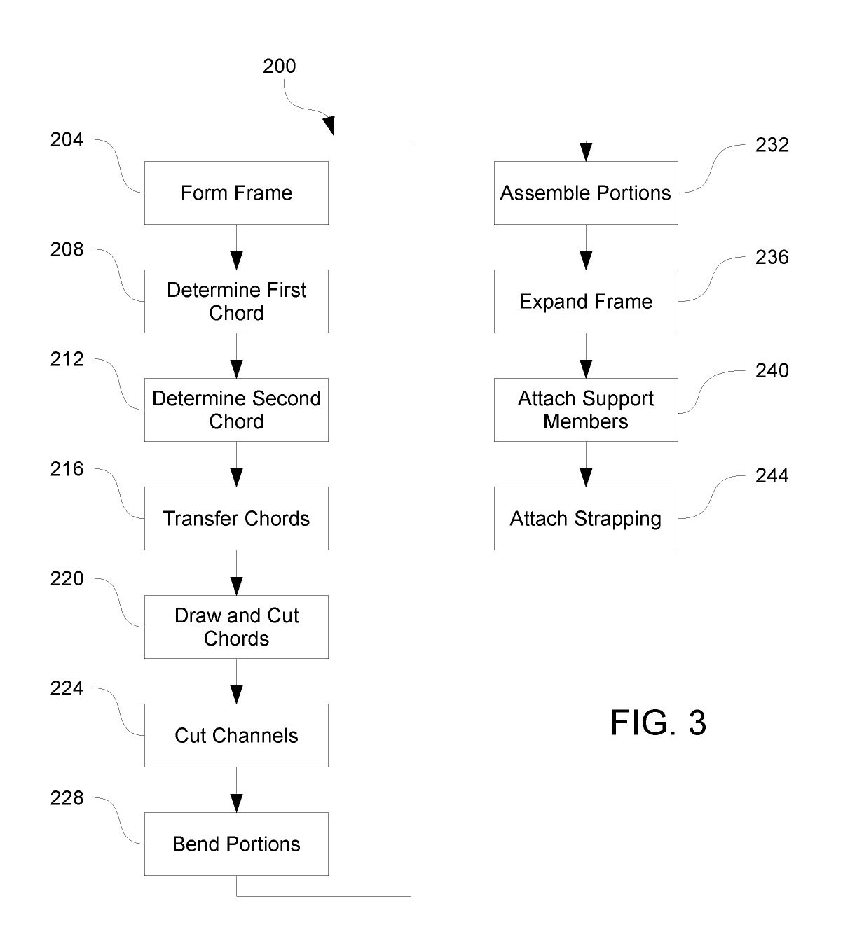

Turning now to FIG. 3, there is shown a process 200 for making a barrel evaporator, such as barrel evaporator 100, according to an embodiment of the present disclosure. A barrel evaporator constructed according to process 200 provides for parallel sidewalls after the frame is formed and supports both a baffled tray, such as baffled tray 108, as well as a set of grill grates (not shown), suitable for using the evaporator as a grill when the baffled tray is not installed within the frame.

At step 204, a frame, such as frame 104, is modified to accommodate the other components of the barrel evaporator. In an exemplary embodiment 204, the frame is formed so as to have predetermined openings associated with a desired configuration, e.g., appropriate inlet for a fuel source, exhaust system, and for a baffled tray, such as baffled tray 108. In an exemplary embodiment, the frame is placed on a level surface (shown in FIG. 5 as surface B) and aligned upon a set of feet 136 such that the frame is balanced and level from front to back (proximate to distal end).

At step 208, a first chord 160 (as shown in FIG. 5) when viewing the frame from one of the ends) is determined on the proximate end of the frame. The first chord typically has a length that is about the width of a baffled tray, such as baffled tray 108. In an exemplary embodiment, when the width of the tray is 20″, the length of the first chord is about 20 inches. In a preferred embodiment, first chord is parallel with the surface that the barrel evaporator will rest on.

At step 212, a second chord 164 (as shown in FIG. 5) is determined that is parallel to and less than the length of the first chord. In an exemplary embodiment, when baffled tray is about 20″ in width, second chord is about 18″ long and is substantially parallel to first chord.

At step 216, each chord is transferred from the proximate end of the frame to the distal end (or vise-a-versa, when the chords are initially determined on the distal end of the frame). Transferring the chords from one end of the barrel to the other may be accomplished by, for example, using a level.

At step 220, a cutout portion, such as cutout portion 132 (FIG. 2), is removed. Cutout portion is defined by longitudinal sides that are coextensive with connection lines that join the ends of second chord on each of the proximate and distal ends of the frame. Cutout portions' lateral edges are near the proximate and distal ends of the frame—typically equidistant from each end of the frame. The cut lateral edges are typically covered by strapping 168 (FIG. 1) (as discussed further below).

At step 224, channels (channels 172 (FIG. 2)) are cut between longitudinal lines connecting the ends of second chord and first chord. In an exemplary embodiment, the cuts between these longitudinal lines are generally triangular and occur at the ribs in a standard 55 gallon drum. The channels facilitate bending in the next step.

At step 228, the portion between the connecting lines that connect the first and second chords on each end of the frame are bent inwards towards the center of the frame. In general, the bending results in the formation of a shelf, such as shelf 166, wherein these opposing portions of the frame are substantially level with each other, i.e., one side of the shelf has an elevation that is substantially similar to the opposing side. It is desirable for the baffled tray to be substantially level when in use and thus it is generally preferred that the bending results in a level surface both longitudinally and laterally (across the opposing bends). It should be noted that the bending at step 228 typically results in the frame having an undesirable hourglass shape.

At step 232, other portions of the frame are adapted to receive other components. For example, the frame may be cut to accommodate the exhaust and door.

At step 236, the frame is expanded so as to reestablish the parallelism between the opposing longitudinal cuts (to remove the hourglass shape). In an exemplary embodiment, expansion is achieved by forcibly striking the barrel proximate the channels cut into the barrel at step 224.

At step 240, support members are attached to the bend portions that resulted from step 228. In an exemplary embodiment, the support members are angle iron members that are attached to the bent portions via means known in the art, e.g., screws or welding. The support members serve to dissuade movement of the baffled tray when installed, reduce exhaust escape around the baffled tray, and to further support the baffled tray.

At step 244, strapping is attached near the proximate and distal cuts that were made for cutout portion. The installation of strapping reduces the incidents of accidental cuts that may occur with users touching the cut edges of the frame (if an issue).

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of constructing an evaporator comprising:
providing a cylindrical frame;
determining a first chord on an end of the cylindrical frame, the first chord having a first and a second end;
transferring the first and second ends of the first chord to the opposite end of the cylindrical frame so as to form two parallel longitudinal cut lines;
cutting along the two parallel longitudinal cut lines; and
bending portions of the cylindrical frame to form a shelf.

2. A method of constructing an evaporator according to claim 1, further comprising expanding the cylindrical frame such that the portions are substantially parallel and square with each other.

3. A method of constructing an evaporator according to claim 1, wherein the cylindrical frame is a barrel.

4. A method of constructing an evaporator according to claim 1, wherein the shelf has parallel sides, the parallel sides being separated by a width sufficient to accept a tray.

5. A method of constructing an evaporator according to claim 4, wherein the first chord length is slightly less than the width of the tray.

6. A method of constructing an evaporator according to claim 5, further including:
determining a second chord on an end of the cylindrical frame, the second chord having a third and a fourth end; and
transferring the third and fourth ends of the second chord to the opposite end of the cylindrical frame so at to form two parallel bend lines.

7. A method of constructing an evaporator according to claim 6, wherein the bending is accomplished by bending the portion of the cylindrical frame residing between each bend line and the corresponding respective longitudinal cut line.

8. A barrel evaporator comprising:
a baffled tray; and
a cylindrical frame including a shelf and an opening, the shelf being disposed on two parallel sides of the cylindrical frame, wherein the shelf is designed and configured to support the baffled tray and the opening is sized to allow the baffled tray to rest partially within the cylindrical frame.

9. A barrel evaporator according to claim 8, wherein the baffled tray includes a plurality of baffles.

10. A barrel evaporator according to claim 8, wherein the cylindrical frame is a barrel.

11. A barrel evaporator according to claim 8, wherein the shelf is formed from portions of the cylindrical frame.

12. A barrel evaporator according to claim 8, wherein the shelf is formed after the removal of a cutout portion from the cylindrical frame.

13. A barrel evaporator according to claim 12, wherein the shelf is formed by bending a portion of the cylindrical frame.

14. A barrel evaporator according to claim 13, wherein parallelism of the cylindrical frame is reestablished after forming the shelf.

15. A barrel evaporator according to claim 8, further including an exhaust system.

16. A barrel evaporator according to claim 8, wherein the outside edge of the shelf is approximately equal to the width of the baffled tray.

17. A barrel evaporator according to claim 16, wherein a support member is affixed to the shelf, the support member resisting movement of the baffled tray when the baffled tray is resting on the shelf.

18. A barrel evaporator according to claim 8, wherein the baffled tray is removably coupled to the cylindrical frame.

19. A barrel evaporator according to claim 8, wherein the baffled tray includes an exit port.

20. A barrel evaporator according to claim 8, wherein the dimensions of the baffled tray are approximately 30″ by 20″ by 6″.
